SEQUENCE LISTING (3 sequences)

SEQ ID NO: 1 - DNA, 2903 bp, Haemophilus influenzae
  misc_feature (1)..(2903): 23S rRNA
gtatagttaagtgactaagcgtacaaggtggatgccttggcaatcagaggcgaagaaggacgtgctaatctgcgaaaagcttggatgagtcgataagaggcgtttaatccaagatatccgaatggggaaacccagtagatgaagaatctactatcaacaagtgaattcatagcttgttgaggcaaaccgggagaactgaaacatctaagtaccccgaggaaaagaaatcaaccgagatttcgtcagtagcggcgagcgaaagcgaaagagccagtaagtgatagcaatatagtgaggagaatgtgttgggaagcacaatcaaagagggtgataatcccgtatctaaaaaccatattgtggtactaagctaacgagaagtagggcgggacacgtgatatcctgtttgaagaaggggggcccatcctccaaggctaaatactcctgattgaccgatagtgaaccagtactgtgaaggaaaggcgaaaagaaccccggtgaggggagtgaaatagaacctgaaaccttgtacgtacaagcagtgggagcgagggcaaccttgtgactgcgtaccttttgtataatgggtcagcgacttatattttgtagcgaggttaaccgaataggggagccgaagggaaaccgagtcttaactgggcgaatagttgcaaggtatagacccgaaacccggtgatctagccatgggcaggttgaaggttgggtaacactaactggaggaccgaaccgactaatgttgaaaaattagcggatgacttgtggctgggggtgaaaggccaatcaaaccgggagatagctggttctccccgaaatctatttaggtagagccttgaggtgacacctttgggggtagagcactgtttcggctagggggccatcccggcttaccaacccgatgcaaactacgaataccaaagagtgatactcaggagacacacggcgggtgctaacgtccgtcgtggagagggaaacaacccagaccgccagctaaggtccccaagtctatattaagtgggaaacgaagtgggaaggcttagacagctaggatgttggcttagaagcagccatcatttaaagaaagcgtaatagctcactagtcgagtcggcctgcgcggaagatgtaacggggctgaaatatagcaccgaagctgcggcatcagaatttattctgttgggtaggggagcgttgtgtaagcggaagaaggttcatcgagaggtgggctggacgtatcacaagtgcgaatgctgacataagtaacgataaaacgggtgaaaaacccgttcgccggaagaccaagggttcctgtccaacgttaatcggggcagggtgagtcggctcctaaggcgaggctgaaaagcgtagtcgatgggaaacaggttaatattcctgtacttggtaaagctgcgatgtggggacggagtaggttaggttatcgcactgttggatatgtgcgtttaagttggtaggtgggaagtttaggcaaatccggacttccttaacacagagagatgatgacgaggctctacggagctgaagtaactgataccacacttccaggaaaagccactaagcgaaaggctttactaaaccgtactgaaaaccgacacaggtggtcaggtagagaatactcaggcgcttgagagaactcgggtgaaggaactaggcaaaatagcaccgtaacttcgggagaaggtgcgccggcgtagattgtaagggctagcccctgaaggttgaaccggtcgaagataccagctggctgcaactgtttattaaaaacacagcactctgcaaacacgaaagtggacgtatagggtgtgatgcctgcccggtgctggaaggttaattgatggtgtcatcgaaagagaagcacctgatcgaagccccagtaaacggcggccgtaactataacggtcctaaggtagcgaaattccttgtcgggtaagttccgacctgcacgaatggcataatgatggccaggctgtctccacccgagactcagtgaaattgaaatcgccgtgaagatgcggtgtacccgcggctagacggaaagaccccgtgaacctttactatagcttgacactgaacattgaattttgatgtgtaggataggtgggagcctttgaagcagtgacgccagtcattgtggaggcgaccttgaaataccaccctttaacgtttgatgttctaacgaagatgacgaaacgtggtctcggacagtgtctggtgggtagtttgactggggcggtctcctcccaaagcgtaacggaggagcacgaaggtttgctaatcacggtcggacatcgtgaggttagtgcaatggtataagcaagcttaactgcgagacagacaagtcgagcaggtacgaaagtaggtcatagtgatccggtggttctgaatggaagggccatcgctcaacggataaaaggtactccggggataacaggctgataccgcccaagagttcatatcgacggcggtgtttggcacctcgatgtcggctcatcacatcctggggctgaagtaggtcccaagggtatggctgttcgccatttaaagtggtacgcgagctgggtttagaacgtcgtgagacagttcggtccctatctgccgtgggcgtaggatgattgattggggctgctcctagtacgagaggaccggagtggacgcatcactggtgttccggttgtgtcgccagacgcattgccgggtagctaaatgcggaagagataagtgctgaaagcatctaagcacgaaacttgccaagagatgagtcatccctgactttaagtcagtaagggttgttgtagactacgacgtagataggttgggtgtgtaagtgatgtgagtcattgagctaaccaatactaattgcccgagaggcttaact

SEQ ID NO: 2 - DNA, 23 bp, Artificial Sequence
  Forward primer for 23S rRNA
gcgtaccttttgtataatgggtc

SEQ ID NO: 3 - DNA, 19 bp, Artificial Sequence
  Reverse primer for 23S rRNA
cagaccgccagctaaggtc

(19) United States
(12) Patent Application Publication
(10) Pub. No.: US 2009/0215653 A1
(43) Pub. Date: Aug. 27, 2009

(54) DEVICE FOR HYBRIDIZATION CHAMBERS PREVENTING AIR BUBBLES AND HYBRIDIZATION DEVICE COMPRISING THE SAME DEVICE

(75) Inventor: Myo-yong LEE, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/850,917

(22) Filed: Sep. 6, 2007

(30) Foreign Application Priority Data
Dec. 27, 2006 (KR) 10-2006-0135013

(51) Int. Cl. C40B 60/00

(52) U.S. Cl. 506/33

(57) ABSTRACT

A device for a hybridization chamber includes a support including an engagement receiving member which receives a microarray, the engagement receiving member engages with the microarray, a hybridization chamber frame which forms the hybridization chamber when in contact with the microarray, a sealing member disposed on the hybridization frame, the sealing member defines a region of the hybridization chamber and a cover coupled with the support and the hybridization chamber frame, wherein one end of the cover is coupled with the support using a hinge, and an opposite end of the cover includes a compression coupling means.

This application claims priority to Korean Patent Application No. 10-2006-0135013, filed on Dec. 27, 2006, and all the benefits accruing therefrom under 35 U.S.C. §119, the contents of which in its entirety are herein incorporated by reference.

### BACKGROUND OF THE INVENTION

1. Field of the Invention

The present invention relates to a device for a hybridization chamber, and more particularly, to a device for a hybridization chamber which prevents a formation of air bubbles and a hybridization device comprising the same device.

2. Description of the Related Art

Microarrays are biological microchips in which an array of biomolecular probes such as deoxyribonucleic acid (“DNA”), DNA fragments, complementary DNA (“cDNA”), oligonucleotide, ribonucleic acid (“RNA”), RNA fragments or the like, of which sequences are known, are immobilized on a surface of a small solid substrate made of a material such as surface-modified glass, silicon, nylon or the like in a high density. By detecting hybridization between the biomolecular probes on the microarrays and target biomolecules, gene expressions, genetic defects, protein distributions and response patterns can be analyzed. When biomolecules that can act as a probe biomolecule for a target molecule are immobilized on the surface of a microarray, and a sample for assay is applied to the microarray, the probe biomolecule can detect specific target biomolecules within the sample. The biomolecules in the sample bind differently with the probe biomolecules immobilized on the surface of the microarray depending on a sequence complementarity or a binding affinity, thereby the biomolecules hybridize with specific probe biomolecules. Information on biomolecules, such as nucleic acids, that are included in the sample can be obtained by detecting and analyzing a hybridization thereof. However, in order to obtain accurate results, hybridization is required to occur uniformly over entire spots of the microarray in which probes are distributed. Further, a sealed hybridization chamber is required in order to minimize leakage or evaporation of a hybridization solution during a hybridization reaction and to provide and control appropriate conditions, such as temperature and agitation, for the hybridization reaction to effectively perform hybridization.

In practical uses, hybridization reactions may be interrupted in spots where probes are distributed since a hybridization solution may not be uniformly distributed throughout an entire region of the microarray. For example, air bubbles may be generated when a sample is injected into a sealed hybridization chamber, or air bubbles may leak from the sample solution when the hybridization chamber is heated for the hybridization reaction. Particularly, if air bubbles are captured in the hybridization solution within the hybridization chamber during the hybridization reaction, heat cannot be uniformly transferred due to the air bubbles. Therefore, effective spots may be observed on only certain parts of the microarray surface, and thus the obtained results cannot be accurate. Further, air bubbles block a path between the surface of the microarray on which biomolecules are immobilized and the hybridization solution, and thus sometimes the target biomolecules within the sample cannot be brought into contact with the probe biomolecules.

As described above, non-uniform distribution of the hybridization solution on the microarray and the presence of air bubbles in the hybridization chamber may significantly affect efficiency, accuracy and reproducibility of an analysis. Therefore, various methods have been attempted to ensure uniform distribution of the hybridization solution on the microarray. For example, stirring, centrifugal force, surfactant, or even generation of air bubbles have been used for the purpose of preventing interruption of the hybridization reaction due to the air bubbles. U.S. Pat. No. 6,432,696 discloses a method of removing air bubbles from a hybridization solution by inclining a slide substrate assembly by about 10 degrees, while a sample is injected into a hybridization chamber. U.S. Pat. No. 7,022,157 discloses a hybridization device comprising a structure having a gas permeable membrane as an array chamber, and a hybridization method comprising injecting a sample into a hybridization device and degassing the sample under vacuum. However, such methods and associated devices require additional steps and devices in order to remove air bubbles from a hybridization solution. Although various devices for and methods of preventing air bubble formation or removing formed air bubbles have been previously developed, devices for and methods of effectively preventing air formation within the hybridization chamber are still needed.

### BRIEF SUMMARY OF THE INVENTION

Air bubbles may be formed since a hybridization solution cannot easily approach a space around edges between a hybridization chamber frame and a sealing member which has an annular sealing surface located at a lower surface of the hybridization chamber frame, when the hybridization solution including a sample is injected into a hybridization chamber, and thus the inventors of the present invention have completed the present invention.

The present invention provides a device for a hybridization chamber preventing formation of air bubbles which interrupt hybridization between target biomolecules included within a sample and probe biomolecules immobilized on a microarray.

The present invention also provides a microarray hybridization device including a device for a hybridization chamber preventing formation of air bubbles which interrupt hybridization.

According to an exemplary embodiment of the present invention, there is provided a device for a hybridization chamber including a support including an engagement receiving member which receives a microarray, the engagement receiving member engages with the microarray, a hybridization chamber frame which forms a hybridization chamber when in contact with the microarray, a sealing member disposed on the hybridization chamber frame, the sealing member defines a region of the hybridization chamber and a cover coupled with the support and the hybridization chamber frame, wherein one end of the cover is coupled with the support using a hinge, and an opposite end of the cover includes a compression coupling means.

According to another exemplary embodiment of the present invention, there is provided a microarray hybridization device including a device for a hybridization chamber as defined above.

### BRIEF DESCRIPTION OF THE DRAWINGS

The above and/or other aspects, features and advantages of the present invention will now become more apparent by describing in detail exemplary embodiments thereof with reference to the attached drawings, in which:

FIG. 1A illustrates an exemplary embodiment of a hybridization chamber frame according to the present invention;

FIG. 1B illustrates a microarray disposed on a support in an exemplary embodiment of a device for a hybridization chamber according to the present invention;

FIG. 1C illustrates a hybridization chamber frame assembled onto the microarray-support assembly of FIG. 1B;

FIG. 1D illustrates a sealed state of a cover and the hybridization chamber frame-microarray-support assembly of FIG. 1C;

FIG. 1E illustrates an exemplary embodiment of a process of injecting a sample into the hybridization chamber of FIG. 1D;

FIG. 2A is a cross-sectional schematic diagram illustrating an operation of an exemplary embodiment of a cover in an exemplary embodiment of a device for a hybridization chamber according to the present invention;

FIG. 2B is a cross-sectional schematic diagram illustrating injecting a sample into a hybridization chamber in a sealed state;

FIG. 3 is a photograph illustrating a top plan view of a hybridization chamber in which air bubbles are formed after injecting a sample;

FIG. 4A is cross-sectional schematic diagram view of an exemplary embodiment of a device for a hybridization chamber;

FIG. 4B is an enlarged cross-sectional schematic diagram view of portion “A” illustrated in FIG. 4A;

FIG. 4C is a cross-sectional schematic diagram illustrating a magnified view of portion “B” of FIG. 4B, which is a space between a sealing member having an annular sealing surface disposed at a lower surface of a hybridization chamber frame and an edge of the hybridization chamber frame which causes air bubble formation in the hybridization chamber after injecting a sample into a completely sealed hybridization chamber;

FIG. 5A is cross-sectional schematic diagram view of another exemplary embodiment of a device for a hybridization chamber;

FIG. 5B is an enlarged cross-sectional schematic diagram view of portion “A” illustrated in FIG. 5A;

FIG. 5C is a cross-sectional schematic diagram illustrating a magnified view of portion “B” of FIG. 5B which is a space between a sealing member having an annular sealing surface disposed at a lower surface of a hybridization chamber frame and an edge of the hybridization chamber frame which is chamfered in a completely sealed hybridization chamber prepared using an exemplary embodiment of a device for a hybridization chamber according to the present invention;

FIG. 6A is a photograph illustrating a top plan view of a hybridization chamber in which air bubbles are not formed after injecting a sample; and

FIG. 6B is a photograph illustrating a top plan view of results of a hybridization reaction using an exemplary embodiment of a device for a hybridization chamber according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will now be described in more detail with reference to the accompanying drawings, in which exemplary embodiments of the invention are shown. The invention may, however, be embodied in many different forms and should not be construed as being limited to the embodiments set forth herein, rather, these embodiments are provided so that this disclosure will be thorough and complete, and will fully convey the concept of the invention to those of ordinary skill in the art.

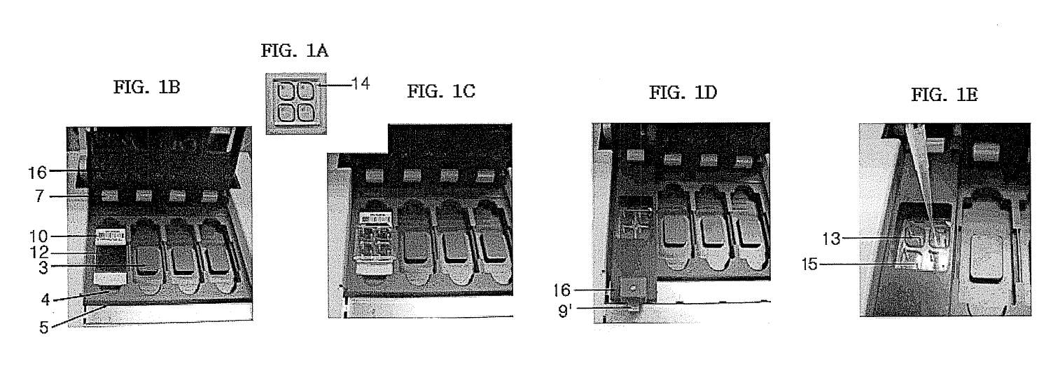

FIG. 1A illustrates an exemplary embodiment of a hybridization chamber frame 14 according to the present invention. FIGS. 1B through 1E illustrate an exemplary embodiment of a process of assembling a hybridization chamber 11 according to the present invention. FIG. 1B illustrates a microarray 12 disposed on a support 4 in an exemplary embodiment of a device for a hybridization chamber according to the present invention. FIG. 1C illustrates a hybridization chamber frame 14 assembled onto the microarray-support assembly of FIG. 1B. FIG. 1D illustrates a sealed state of a cover 16 and the hybridization chamber frame-microarray-support assembly of FIG. 1C. FIG. 11E illustrates an exemplary embodiment of a process of injecting a sample into the hybridization chamber 11 of FIG. 1D.

First, a microarray 12 is installed on a peltier 10 disposed on a support 4, on which an engagement receiving member 3 which receives the microarray is formed. A hybridization chamber frame 14 is installed onto the peltier-microarray assembly by bringing the hybridization chamber frame 14 into contact with the microarray 12 such that a hybridization region of the microarray 12 corresponds to a region of the hybridization chamber frame 14 in order to form a hybridization chamber 11. One end of a cover 16 is coupled to the support 4 via a hinge 7, and the other end of the cover 16 includes a compression coupling means 9 which is coupled to the support 4. The compression coupling means 9 is coupled to the support such that a coupling means receiving member 5, which is disposed at an end of the support 4 which opposes the hinge 7, is coupled to the compression coupling means 9 to cover the support-microarray-hybridization chamber frame assembly. A hybridization solution including a sample is injected into an inlet 13 which is disposed at an upper portion of the hybridization chamber frame 14, and thereby into a formed hybridization chamber 11. In exemplary embodiments, a second cover may further be included in order to improve a sealing state of the hybridization chamber 11.

In further exemplary embodiments, the device for a hybridization chamber 11 of the present invention may further include a support 4 on which a microarray 12 which is to be analyzed is placed.

In exemplary embodiments, the support 4 for a microarray 12 may include an engagement receiving member 3 which receives a microarray 12 and is engaged with the microarray 12. In further exemplary embodiments, a temperature control device may further be included at an upper or a lower portion of the engagement receiving member 3 of the support 4 in order to control temperatures in the hybridization chamber 11. In exemplary embodiments, the temperature control device may be a heater. In an exemplary embodiment, the temperature control device may be a peltier device.

In exemplary embodiments, the microarray 12 may be a microchip where an array of biomolecular probes to be analyzed are immobilized on a solid substrate made of a material such as surface-modified glass, silicon, nylon, plastic, or the like. In exemplary embodiments, the biomolecules immobilized on the microarray 12 may be selected from the group consisting of DNA, RNA, peptide nucleic acid (“PNA”), locked nucleic acid (“LNA”) and peptide proteins. The microarray 12 may be prepared beforehand and disposed on the support 4 of the device for hybridization chamber when required.

In exemplary embodiments, the device for a hybridization chamber of the present invention may include a hybridization chamber frame 14.

The hybridization chamber frame 14 is in contact with the microarray 12 such that a hybridization region of the microarray 12 corresponds to a region of the hybridization chamber frame 14 which forms the hybridization chamber 11. A region of the hybridization chamber 11 is defined by a sealing member 1.

As used herein, the expression, “hybridization region” refers to a region in which a signal of hybridization between target biomolecules and probe biomolecules, which are immobilized on the microarray 12 as spot, can be detected.

In exemplary embodiments, the hybridization chamber frame 14 may include at least one region in which a hybridization chamber 11 is formed, and may be entirely or partially compressed between the support 4 for the microarray 12 and the cover 16 in order to form sealed hybridization chambers 11, in which hybridization reactions occur. In further exemplary embodiments, a groove may be formed on a lower surface of the hybridization chamber frame 14, and a region which forms a hybridization chamber 11 may be defined by a sealing member 1 which is disposed in the groove. Accordingly, when the hybridization chamber frame 14 is in contact with the microarray 12 disposed on the support to form a hybridization chamber frame-microarray-support assembly, the cover 16, which includes a compression coupling means at one end, attaches to the hybridization chamber frame-microarray-support assembly. The compression coupling means, which is disposed at one end of the cover 16, is coupled to the coupling means receiving member 5 on the support 4, to thereby form sealed hybridization chambers 11.

In exemplary embodiments, the sealing member 1 of the hybridization chamber frame 14 applied to the surface of the microarray 12 may be a sealing member 1 including an annular sealing surface. In an exemplary embodiment, the sealing member 1 including the annular sealing surface may be an O-ring.

In exemplary embodiments, materials used to form the sealing member 1 may be any polymer having an elasticity which can be transformed by compression. In an exemplary embodiment, a nitril-based rubber is used to form the sealing member 1, and preferably a nitril butadiene rubber may be used to form the sealing member 1.

The cover 16 may include a hinge or a compression coupling means at one end and a compression coupling means at an opposite end.

The compression coupling means of the cover 16 may be a hook, and a hook hole may be included at one end of the support 4, to which the hook of the cover 16 is coupled.

In exemplary embodiments of the present invention, the cover 16 may include hooks at both ends of the cover 16.

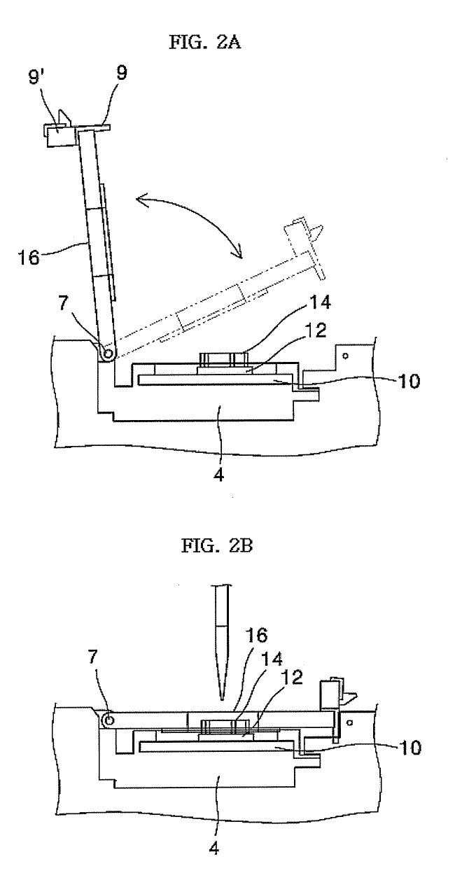

FIG. 2A is a cross-sectional schematic diagram illustrating an operation of an exemplary embodiment of a cover 16 in a device for a hybridization chamber 11 according to the present invention. As illustrated in FIG. 2A, one end of a cover 16 is connected to a support 4 by a hinge 7 and the opposite end of the cover 16 includes a hook 9 which is a compression coupling means, wherein a compression spring is installed in the hook 9. Thus, when the cover 16 covers the support 4-microarray 12-hybridization chamber frame 14 assembly, and the hook 9 is coupled to the hook hole at one end of the support 4, pressure is applied to the assembly by the compression coupling means and thereby sealed hybridization chambers 11 are formed. When the hybridization chamber assembly is disassembled, a disassembling lever 9′ which is installed at an upper portion of the hook 9 of the cover 16 is operated. FIG. 2B is a cross-sectional schematic diagram illustrating injecting a sample into a hybridization chamber 11 which is completely sealed by the cover 16, referred to as a “sealed state.”

In an exemplary embodiment of the present invention, the hybridization chamber 11 may be opened and closed using the cover 16 which is connected to the support 4 by the hinge 7, which is installed at one end of the cover 16.

Further, an inlet 13 and an outlet 15 which are to be used for an injection of a sample, etc. may be included on an upper surface of the hybridization chamber frame 14 which forms the region of the hybridization chamber 11.

In an exemplary embodiment of the present invention, a hybridization solution including a sample, a washing solution and the like may be injected into the hybridization chamber 11 through the inlet 13 at the upper portion of the hybridization chamber frame 14, and solutions to be removed are discharged from the hybridization chamber 11 through the outlet 15.

In an exemplary embodiment of the present invention, interior edges of the hybridization chamber frame 14 which are in contact with the sealing member I disposed in the groove, which is formed on the lower surface of the hybridization chamber frame 14, are chamfered.

As used herein, the term chamfer refers to a mechanical processing of easing sharpness of edges at which more than two surfaces meet by treating the edges to have an obtuse angle which is greater than 90 degree, and may include a radius.

In exemplary embodiments, a chamfer 2 may be in a range of about 0.1 nm to about 0.5 nm. When the chamfer 2, and more particularly a radius (“R”) of the chamfer 2, is less than about 0.1 nm, an effect of preventing air bubble formation is not sufficient since the hybridization solution, including the sample, injected into the hybridization chamber 11 cannot easily approach a space formed between the sealing member 1 connected to a lower surface of the hybridization chamber frame 14 and an interior edge of the hybridization chamber frame 14. On the other hand, when the chamfer 2, or R, is greater than about 0.5 nm, an angle between interior edges of the hybridization chamber 11 and a surface of the microarray 12 is too small, and thus effective hybridization regions may thereby decrease.

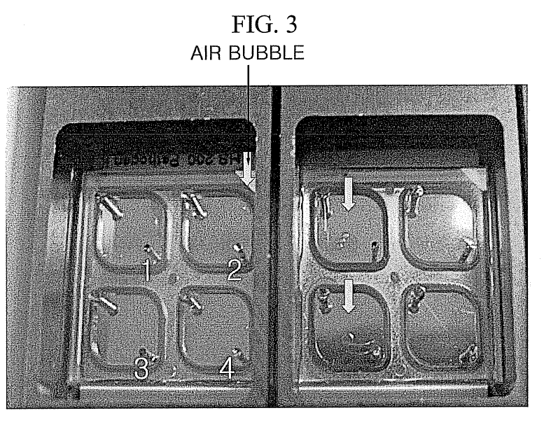

FIG. 3 is a photograph illustrating a top plan view of a hybridization chamber 11 in which air bubbles are formed after injecting a sample. As illustrated in FIG. 3, air bubbles are formed in a hybridization chamber 11 after injecting a sample when a hybridization chamber 11 is prepared using an exemplary embodiment of a device for a hybridization chamber 11.

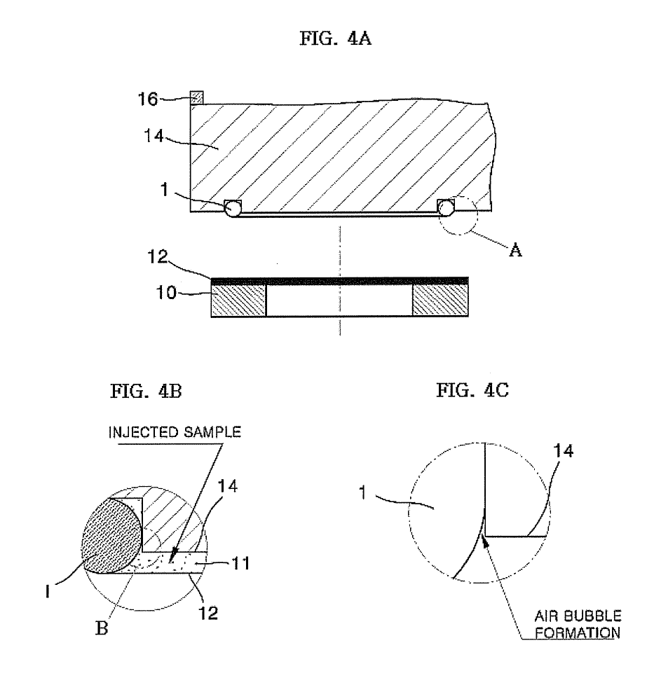

FIG. 4A is cross-sectional schematic diagram view of an exemplary embodiment of a device for a hybridization chamber. FIG. 4B is an enlarged cross-sectional schematic diagram view of portion “A” illustrated in FIG. 4A. FIG. 4C is a cross-sectional schematic diagram illustrating a magnified view of portion “B” of FIG. 4B, which is a space between a sealing member 1 having an annular sealing surface disposed at a lower surface of a hybridization chamber frame 14 and an edge of the hybridization chamber frame 14 which causes air bubble formation in the hybridization chamber 11 after injecting a sample into a completely sealed hybridization chamber 11.

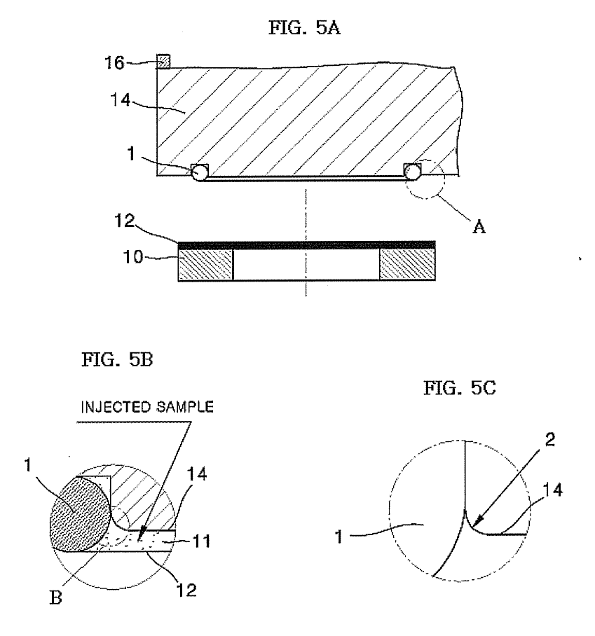

FIG. 5A is cross-sectional schematic diagram view of another exemplary embodiment of a device for a hybridization chamber. FIG. 5B is an enlarged cross-sectional schematic diagram view of portion “A” illustrated in FIG. 5A. FIG. 5C is a cross-sectional schematic diagram illustrating a magnified view of portion “B” of FIG. 5B which is a space between a sealing member 1 having an annular sealing surface disposed at a lower surface of a hybridization chamber frame 14 and an edge of the hybridization chamber frame 14 which is chamfered in a completely sealed hybridization chamber 11 prepared using an exemplary embodiment of a device for a hybridization chamber according to the present invention.

As illustrated in FIG. 4, air bubbles may be formed since a hybridization solution including a sample injected into the hybridization chamber 11 cannot easily approach a space surrounding edges formed between the sealing member 1 in the groove at a lower portion of the hybridization chamber frame 14 and the hybridization chamber frame 14. However, as illustrated in FIG. 5, in an exemplary embodiment of a hybridization chamber 11 according to the present invention, when edges formed between a sealing member 1 having annular sealing surface at a lower portion of the hybridization chamber frame 14 and the hybridization chamber frame 14 are chamfered, a hybridization solution injected into the hybridization chamber 11 can easily approach an entire region of the hybridization chamber 11, and thereby a formation of air bubbles can be prevented or substantially reduced.

According to an exemplary embodiment of the present invention, a device for a hybridization chamber 11 provides a hybridization chamber frame 14 which forms four hybridization chambers 11. The hybridization chamber frame 14 is placed on a microarray 12 disposed on a microarray support, and a cover 16 is added to prepare the hybridization chambers 11. In exemplary embodiments, the hybridization chambers 11 formed by applying pressure to the cover 16 coupled to the support 4 and the hybridization chamber frame 14 may include a rectangular shape corresponding to a shape of the microarray 12. However, in exemplary embodiments, the hybridization chambers 11 may include a streamlined shape such that pressure from air injected through air channels at both ends of the hybridization chamber 11 can be uniformly applied to an entire region of the hybridization chamber 11. In exemplary embodiments, the hybridization solution including the sample may be manually injected through an inlet 13 installed at an upper portion of the hybridization chamber frame 14 using a micropipette, or automatically injected through an automatic sample injection device. When the sample is injected, hybridization reactions occur between target biomolecules within the sample and probes which are immobilized on the microarray 12 in the hybridization chamber 11.

The present invention also provides a microarray hybridization device including at least one device for a hybridization chamber 11 for a microarray including a hybridization chamber frame 14 including a structure which prevents air bubble formation, a cover and a microarray support.

In an exemplary embodiment of the hybridization device for a microarray according to the present invention, the device for a hybridization chamber 11 includes the same characteristics as the device for a hybridization chamber 11 of the present invention described above.

In exemplary embodiments, the microarray hybridization device of the present invention may further include a stirring or agitation device and a washing/drying device.

Hereinafter, the present invention will be described in further detail with reference to the following examples. These examples are only for illustrative purposes only and are not intended to limit the scope of the present invention.

### EXAMPLE

### <Preparing a Hybridization Chamber Using a Device for a Hybridization Chamber Preventing Air Bubble Generation>

As illustrated in FIGS. 1B through 1E, a study of whether air bubbles were generated when a sample was injected into a hybridization chamber formed according to an exemplary embodiment of a device for a hybridization chamber according to the present invention and using a hybridization device for a microarray (HS-200) including a device for a hybridization chamber 11 having a support 4 for a microarray 12, a hybridization chamber frame 14 and a cover 16 was conducted.

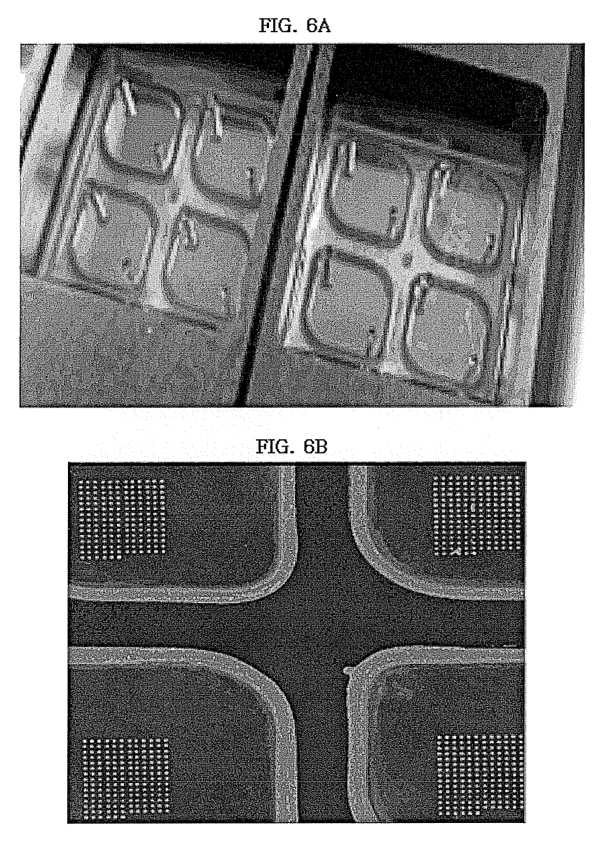

First, the microarray 12 to be analyzed was disposed on a peltier 10 disposed on the support 4 for the microarray 12. The microarray 12 for identifying respiratory infectious pathogens included four hybridization regions, and the hybridization chamber frame 14 included four regions corresponding to the four hybridization regions of the microarray 12, to form hybridization chambers 11. A microarray-hybridization chamber frame assembly was prepared by contacting the hybridization chamber frame 14 with the microarray 12 such that each of the hybridization regions of the microarray 12 corresponded to the regions of the hybridization chamber frame 14. Each region of the hybridization frame 14 is defined by an O-ring disposed in a groove formed at a lower portion of the hybridization chamber frame 14. The cover 16, including a compression coupling means, which covered the microarray-hybridization chamber frame assembly, was coupled to a coupling means receiving member 5 in the support 4, and a pressure of less than 200 mL/min of air flow was applied in order to prepare the hybridization chamber 11. Then, edges of the hybridization chamber frame 14 contacting the O-ring, which was disposed on a lower surface of the hybridization chamber frame 14 was chamfered to a radius of about 0.15 nm to about 0.2 nm in order to uniformly distribute a hybridization solution including a sample injected into the hybridization chamber 11 without an air bubble formation. About 20 to 23 μof a hybridization solution including polymerase chain reaction (“PCR”) products (6×SSPE including 0.005% Triton® X-100) produced using genomic DNA (“gDNA”) obtained from Haemophilus influenzae that codes 23 S rRNA (GenBank Accession No: NC_{—}000907) set forth in SEQ ID NO: 1 as a template and primers set forth in SEQ ID NO: 2 and 3 were injected into the hybridization chamber 11 using a micropipette, and hybridization reaction was performed at 42° C. for 1 hour. Hybridization was effectively performed throughout the entire region of the microarray without any negative effects from air bubbles. FIG. 6A is a top plan photograph view of the hybridization chamber 11 after a sample was injected illustrating a lack of bubble formations. FIG. 6B is a magnified plan view illustrating a hybridization result.

In a hybridization chamber 11 using a device for a hybridization chamber 11 of the present invention, since edges of a hybridization chamber frame 14 contacting with a sealing member 1 including an annular sealing surface at a groove at a lower surface of the hybridization chamber frame 14 are chamfered, a hybridization solution including a sample can easily approach a space formed around the edges between the hybridization chamber frame 14 and the sealing member 1 having the annular sealing surface, and thus generation of air bubbles can be prevented or substantially reduced. Thus, hybridization reaction can be effectively performed through the entire region of a microarray 12 without interruptions of air bubbles by using the device for a hybridization chamber 11 according to the present invention, and therefore precise results can be obtained.

While the present invention has been particularly shown and described with reference to some exemplary embodiments thereof, it will be understood by those of ordinary skill in the art that various changes in form and details may be made therein without departing from the spirit and scope of the present invention as defined by the following claims.

What is claimed is:

1. A device for a hybridization chamber comprising:
a support including an engagement receiving member which receives a microarray, the engagement receiving member engages with the microarray;
a hybridization chamber frame which forms the hybridization chamber when in contact with the microarray;
a sealing member disposed on the hybridization frame, the sealing member defines a region of the hybridization chamber; and
a cover coupled with the support and the hybridization chamber frame, wherein one end of the cover is coupled with the support using a hinge and an opposite end of the cover includes a compression coupling means.

2. The device of claim 1, wherein the hybridization chamber frame contacts the microarray such that a hybridization region of the microarray corresponds to the region of the hybridization chamber which is defined by the sealing member.

3. The device of claim 1, wherein the sealing member comprises an annular sealing surface.

4. The device of claim 1, wherein the compression coupling means is a hook, and an end of the support which corresponds to the hook comprises a hook hole, the hook couples with the hook hole.

5. The device of claim 1, wherein interior edges of the hybridization chamber frame which are in contact with the sealing member are chamfered.

6. The device of claim 5, wherein the interior edges are chamfered in a range of about 0.1 nm to about 0.5 nm.

7. The device of claim 1, wherein the region of the hybridization chamber frame which defines a hybridization chamber comprises an inlet and an outlet on a surface of the hybridization chamber frame.

8. A hybridization device for a microarray comprising
a device for a hybridization chamber, the device for a hybridization chamber comprising:
a support including an engagement receiving member which receives a microarray, the engagement receiving member engages with the microarray;
a hybridization chamber frame which forms the hybridization chamber when in contact with the microarray;
a sealing member disposed on the hybridization frame, the sealing member defines a region of the hybridization chamber; and
a cover coupled with the support and the hybridization chamber frame, wherein one end of the cover is coupled with the support using a hinge and an opposite end of the cover includes a compression coupling means.

9. The device of claim 8, wherein the hybridization chamber frame is in contacts with the microarray such that a hybridization region of the microarray corresponds to the region of the hybridization chamber which is frame that is defined by the sealing member of the hybridization chamber frame.

10. The device of claim 8, wherein the sealing member comprises an annular sealing surface.

11. The device of claim 8, wherein the compression coupling means of the cover is a hook, and an end of the support which corresponds to the hook cover comprises a hook hole, the hook couples with the hook hole.

12. The device of claim 8, wherein interior edges of the hybridization chamber frame which are in contact with the sealing member are chamfered.

13. The device of claim 12, wherein the interior edges are chamfered in a range of about 0.1 nm to about 0.5 nm.

14. The device of claim 8, wherein the region of the hybridization chamber frame which defines a hybridization chamber comprises an inlet and an outlet on a surface of the hybridization chamber frame.
